(19) United States
(12) Patent Application Publication
(10) Pub. No.: US 2012/0159604 A1
(43) Pub. Date: Jun. 21, 2012

(54) Method and System for Communication Between Devices

(75) Inventors: Hristo Bojinov, Palo Alto, CA (US); Dan Boneh, Palo Alo, CA (US)

(73) Assignee: The Board of Trustees of the Leland Stanford, Junior, University, Palo Alto, CA (US)

(21) Appl. No.: 13/208,330

(22) Filed: Aug. 11, 2011

Related U.S. Application Data
(60) Provisional application No. 61/373,068, filed on Aug. 12, 2010.

(51) Int. Cl. G06F 21/00

(52) U.S. Cl. 726/9; 726/3

(57) ABSTRACT

An embodiment of the present invention includes a system for communicating digital data from a preferably small battery powered device (e.g., key-chain or pocket-sized form-factor) to a personal electronic device (e.g., a smartphone such as an iPhone or a Nexus One). The communication mechanism of the present invention can be used as second factor authentication. The present invention can also be used as a key for accessing physical locations such as building. Alternatively, the present invention can be used as a manner for transmitting digital data to a personal electronic device such as a smart phone.

### GOVERNMENT RIGHTS

This invention was made with Government support under contract 0524155 awarded by the National Science Foundation. The Government has certain rights in this invention.

### FIELD OF THE INVENTION

The present invention generally relates to the field of electronic security. More particularly, the present invention relates to token based authentication.

### BACKGROUND OF THE INVENTION

In many situations, technology users are required to provide authenticate for services and access to devices. Existing technologies for second factor authentication often come at a significant cost and require enterprise-wide deployment to be practical. At the same time, authentication is becoming relevant at the scale of a single user. For example, smart phones, which can carry increasingly personal, sensitive data, are susceptible to being misplaced or stolen. Indeed, smart phones and other portable electronic devices hold increasingly sensitive or valuable information that needs to be protected.

In many situations, authentication is carried out via passwords. In implementing password protection for these kinds of devices, a user typically provides a password in order to unlock certain capabilities of the system of interest. This approach has a number of deficiencies. For example, passwords can be easy to guess or hard to remember. They can also be inconvenient to type on a small keypad and can be computationally burdensome to authenticate.

Second factor authentication, or two-factor authentication, has also been used. For example, biometric, token, and smart cards have been implemented in two factor authentication. Regarding biometric data, while useable in certain situations, it cannot be discarded or replaced by the user. Regarding, hardware-based tokens, several variations have been used. Examples include contactless proximity cards, contact-type smartcards, onetime PIN generators such as the RSA SecurID, among others.

RFID tags may be considered, especially because they are relatively inexpensive. A problem with the use of RFID tags is the higher cost and low availability of the reader. For example, at the time of the present invention, an RFID add-on to an SD card costs approximately $50. Table 1 lists some representative examples of hardware tokens along with certain of their attributes and costs.

TABLE 1

| | Price (USD) | | Power | | |
|---|---|---|---|---|---|
| Device | Token | Reader | Token | Reader | Usability |
| RSA SecurID | $50 | >$10,000 | low | low | poor |
| Vasco Digipass | $10 | $500 | low | low | poor |
| Go | | | | | |
| HID Proximity | $2 | $100 | none | average | good |
| RFID | <$1 | $50 | none | average | good |
| Smartcard | $2 | $10 | none | low | average |
| Magnetic stripe | <$1 | $50 | none | low | average |

Common to many of these implementations is a relatively high cost. For example, a central authentication server as required in certain of these techniques can be cost prohibitive in many situations. Also, some of these techniques require high power and two-way communication, and others depend on a specific receiver design (e.g., a smartcard reader).

There is, therefore, a need for a light-weight authentication mechanism suitable for use with many electronic devices including smart phones and other personal technology devices.

### SUMMARY OF THE INVENTION

The paradigm of a physical key is well understood. Physical keys can be less frequently lost and sometimes more carefully guarded than other types of keys such as passwords. The function of keys is well understood and accepted. An embodiment extends from this paradigm to applications in smart phones and other personal technology devices.

An embodiment of the invention includes a system for communicating digital data from a preferably small battery powered device (e.g., key-chain or pocket-sized form-factor) to a personal electronic device (e.g. a smartphone such as an iPhone or a Nexus One). The communication mechanism of the present invention can be used as second factor authentication. The present invention can also be used as a key for accessing physical locations such as building. Alternatively, the present invention can be used as a manner for transmitting digital data to a personal electronic device such as a smart phone.

In another embodiment, a transmitter sends a series of bits by creating a weak magnetic field (such as by using a coil). The receiver is the smart phone that makes use of an on board compass, such as those made of a Hall-effect sensor, to detect the transmitted magnetic field. Because the field is relatively weak and does not require much current to create. The relatively weak signal provides an advantage in security applications because it cannot be easily intercepted and copied.

In another embodiment, the present invention implements a passive circuit using a layout of permanent magnets to represent a digital sequence that does not change in time. A sensor according to an embodiment of the invention uses a compass within a smart phone to to sample the resulting magnetic field as a user manipulates the smart phone in the vicinity of the magnets. The resulting samples are used to recover the number stored via the magnet layout.

An authenticator according to an embodiment of the invention has several advantages compared to traditional keys. For example, it can be programmable to a new state and be less expensive to maintain. An authenticator according to an embodiment of the invention provides increased security at a relatively low cost. It can also combine several identities into one device, thereby eliminating the need to carry various other physical tokens such as on a key chain.

In an embodiment of the invention, a corresponding transmitter device (serving as keys) can be built inexpensively. It can also be designed to consume small amounts of power. Low power consumption makes embodiments of the present invention reliable replacements for keys even in traditional settings such as in gaining physical access to restricted areas.

### BRIEF DESCRIPTION OF THE DRAWINGS

The following drawings will be used to more fully describe embodiments of the present invention.

FIG. 1 includes plots representing reading from a fixed arrangement of magnets according to an embodiment of the invention.

FIG. 2 is a schematic diagram of an embodiment of the present invention that generates, among other things, a magnetic field.

FIG. 3 is a breadboard implementation of the present invention that substantially uses commercially available off-the-shelf components.

FIG. 4 are the results of implementations of time-based encoding on different smart phones according to the present invention.

FIG. 5 are results for various configurations for transmitting a signal using a piezoelectric buzzer.

FIG. 6 is a schematic diagram for microphone-based authentication according to the present invention.

FIG. 7 is a flowchart of a method according to an embodiment of the present invention.

FIG. 8 is a flowchart of a method according to an embodiment of the present invention.

FIG. 9 shows a block diagram of a portable consumer device in accordance with an embodiment of the present invention.

FIG. 10 shows a block diagram of an exemplary computer apparatus that can be used in embodiments of the present invention.

### DETAILED DESCRIPTION OF THE INVENTION

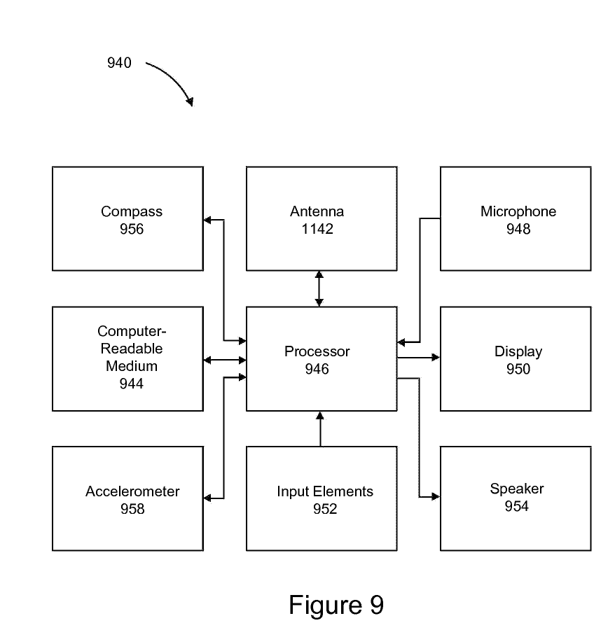

FIG. 9 shows a block diagram of a portable consumer device or mobile device and subsystems that may be present in computer apparatuses in systems according to embodiments.

An exemplary portable consumer device 940 in the form of a cell phone or smart phone may comprise a computer readable medium and a body. The computer readable medium 944 may be present within the body of the phone, or may be detachable from it. The body may be in the form a plastic substrate, housing, or other structure. The computer readable medium 944 may be a memory that stores data and may be in any suitable form including a magnetic stripe, a memory chip, encryption algorithms, private or private keys, etc. The memory also preferably stores information such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc.

The portable consumer device 940 may also include a processor 946 (e.g., a microprocessor) for processing the functions of the portable consumer device 940 and a display 950 to allow a consumer to see phone numbers and other information and messages. The portable consumer device 940 may further include input elements 952 to allow a consumer to input information into the device, a speaker 954 to allow the consumer to hear voice communication, music, etc., and a microphone 948 to allow the consumer to transmit her voice through the portable consumer device 940. The portable consumer device 940 may also include an antenna 942 for wireless data transfer (e.g., data transmission). Antenna 942 is also intended to include other types of contactless communications such as semiconductor chips (or other data storage element) with an associated wireless transfer (e.g., data transmission) element. Antenna 942 can also be associated with transferring and receiving data using a near field communications (“NFC”) capability (or near field communications medium) such as in accordance with a standardized protocol or data transfer mechanism (e.g., ISO 14443/NFC). Near field communications capability is a short range communications capability, such as RFID, Bluetooth®, infra-red, or other data transfer capability that can be used to exchange data between the portable consumer device 640 and an interrogation device. In embodiments of the invention, contactless element 956 can also include an internal compass such as included in certain cell phones or smart phones. Other technologies that can make use of antenna 942 include GPS, WiFi, and Bluetooth communications.

Portable consumer device 940 can include accelerometer(s) 958. Multiple accelerometers can be oriented orthogonally or non-orthogonally to each other. Indeed, portable consumer device 940 can include many other components. Table 2 lists various receivers and transmitters that may be available on a typical portable consumer device 940 along with the medium they use.

TABLE 2

| Name | Medium |
|---|---|
| Microphone | Sound |
| Radio | RF |
| GPS | RF |
| WiFi | RF |
| Bluetooth | RF |
| Compass | Magnetic |
| Accelerometer | Mechanical |
| Camera | Light |
| Light | Light |
| RFID | RF |

Note that regardless of their classification as sensors or “real” signal receivers, all of the above can be used to receive a properly modulated sequence of bits.

The portable consumer device 940 is, therefore, capable of communicating and transferring data and/or control instructions via cellular network as well as other mechanisms.

As will be discussed further below, the various components of a portable consumer device 940 will be described in conjunction with certain embodiments of the invention for exchanging information and providing for secure authentication.

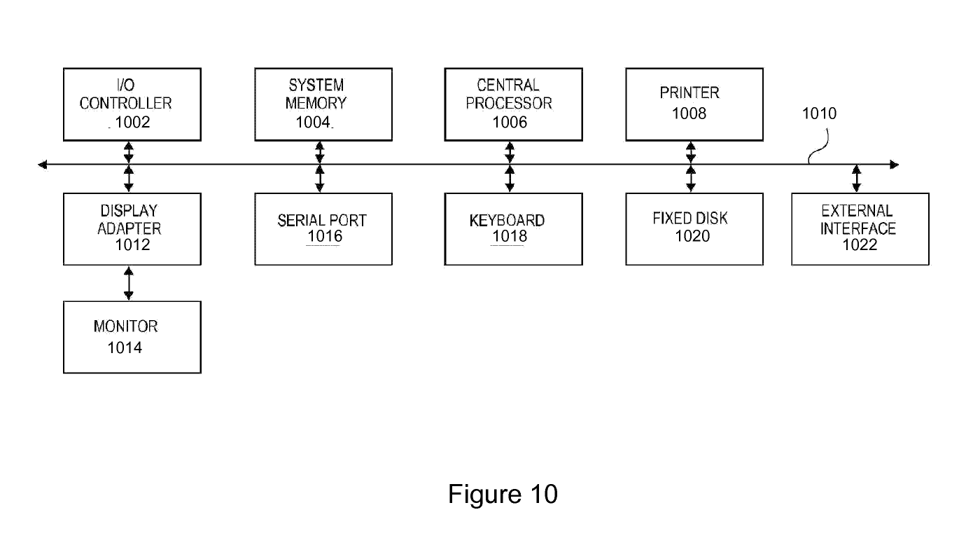

FIG. 10 shows a block diagram of an exemplary computer apparatus that can be used in certain embodiments of the present invention.

The subsystems shown in the figure are interconnected via a system bus 1010. Additional subsystems such as a printer 1008, keyboard 1018, fixed disk 1020 (or other memory comprising computer readable media), monitor 1014, which is coupled to display adapter 1012, and others are shown. Peripherals and input/output (I/O) devices, which couple to I/O controller 1002, can be connected to the computer system by any number of ways known in the art, such as through serial port 1016. For example, serial port 1016 or external interface 1022 can be used to connect the computer apparatus to a wide area network such as the Internet, a mouse input device, or a scanner. The interconnection via system bus 1010 allows the central processor 1006 to communicate with each subsystem and to control the execution of instructions from system memory 1004 or the fixed disk 1020, as well as the exchange of information between subsystems. The system memory 1004 and/or the fixed disk 1020 may embody a computer readable medium.

It should be understood that the present invention as described above can be implemented in the form of control logic using computer software in a modular or integrated manner. Based on the disclosure and teachings provided herein, a person of ordinary skill in the art knows and appreciates other ways and methods to implement the embodiments of the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CDROM. Any such computer readable medium may reside on or within a single computational apparatus, and may be present on or within different computational apparatuses within a system or network.

One or more features from any embodiment may be combined with one or more features of any other embodiment without departing from the scope of the invention.

The present disclosure is illustrative and is not restrictive. Many variations of the invention will become apparent to those skilled in the art upon review of the disclosure. The scope of the invention should, therefore, be determined not with reference to the specification but instead should be determined with reference to the pending claims along with their full scope or equivalents.

An embodiment of the present invention emulates that of a classic mechanical key. Such a key is inexpensive to produce, requires little maintenance, and is traditionally carefully guarded by its owner. Such a key has concrete, easily understood uses including unlocking protected space.

In embodiments of the invention, use is made of sensors already embedded in many portable consumer devices 940. Using these components, an inexpensive token is available that can perform authentication functions using pre-existing handsets. An embodiment of the present invention uses magnetic fields using a compass within a handset. Another embodiment of the invention uses audible sounds as can be interpreted via a speaker or microphone within a portable consumer device 940.

Embodiments of the present invention communicate inexpensively with cell phone, smart phones, laptops and desktop PCs, as well as other items of security infrastructure. Certain of the technology required for the use of the present invention is preferably pre-existing on personal technology devices.

In an embodiment of the present invention described below, a digital compass is used as a receiver for a signal generated by a token of the present invention. In another embodiment, a microphone is used as a receiver for a signal generated by a token of the present invention.

In an embodiment of the present invention, the threat models to be addressed include:
Device theft—prevent unauthorized persons from using a device after it has been lost or stolen.
Unauthorized access—protect infrastructure (electronic devices, offices, buildings) from unauthorized access.

An embodiment of the invention that makes use of a compass as may exist on a portable consumer device 940 such as a cell phone or smart phone will now be described. In this embodiment, a fixed arrangement of permanent magnets was used to encode a number which could be “scanned” by a digital compass. The orientation of permanent magnets was used for encoding in a similar manner as used for the encoding in credit card magnetic strips.

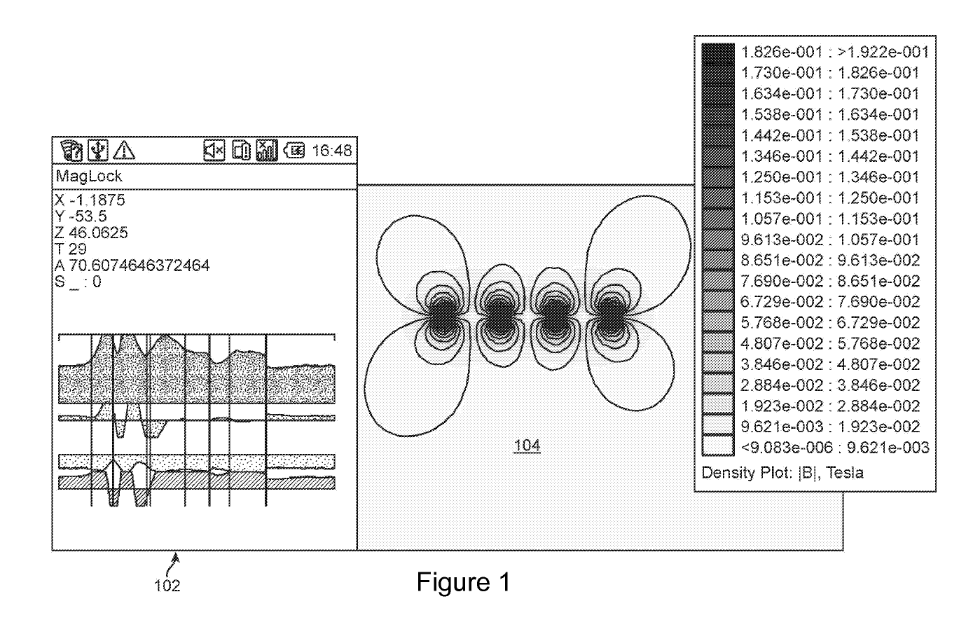

FIG. 1 shows the detected signal versus the simulated magnetic field of such an arrangement. Plot 102 presents the sensor reading from a NS-SN-NS-SN magnet layout where the magnets were placed approximately two inches apart. Plot 104 presents a simulated magnetic field for this arrangement of permanent magnets with polarity aligned horizontally.

This embodiment of the invention implemented particular spacing of the magnets as well as a uniform swiping motion for a reading. Moreover, this embodiment of the invention, implemented a simplified encoding scheme to demonstrate its usefulness. Those of skill in the art will understand, however, that other implementations of the magnets as well as other implementations of encoding are possible. For example, stronger or weaker magnets can be implemented as well as different orientations to incorporate other encoding schemes.

Also, an improvement over a passive arrangement of magnets is an active circuit that is able to modulate a digital signal as a sequence of changes in a magnetic field created by the current in a small inductor. Using this arrangement, the present invention was able to achieve a low-cost, time-based encoding key.

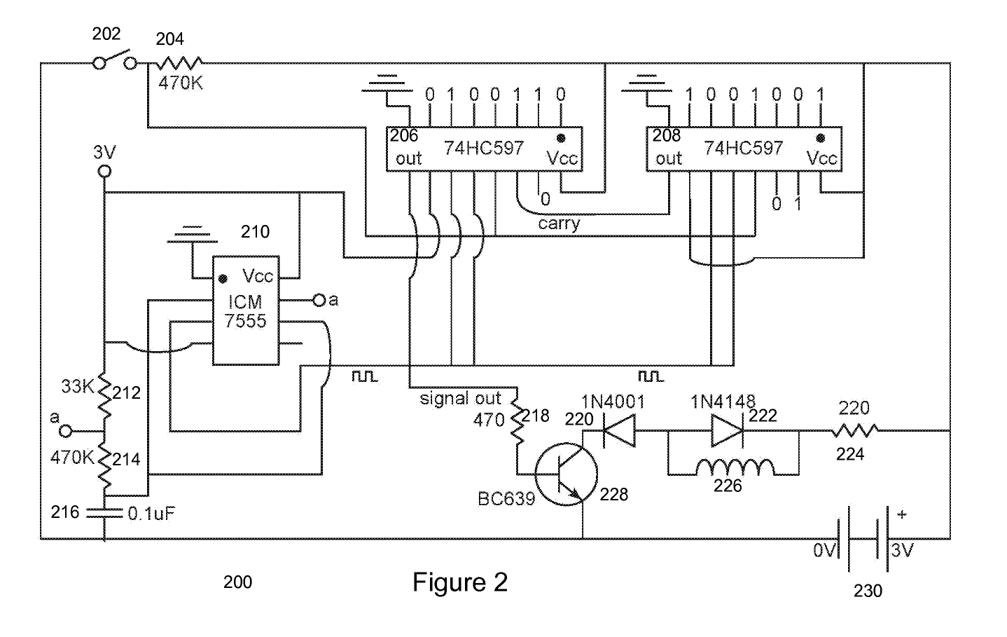

Shown in FIG. 2 is a schematic diagram of a circuit according to an embodiment of the present invention. As shown, circuit 200 is an active circuit which transmits a sequence of bits with the presence or absence of a magnetic field. Circuit 200 includes a timing circuit 210 that is an ICM 7555 timer that generates a signal of a predetermined duty cycle and frequency based on resistors 212 and 214 and capacitor 216. The signal of predetermined duty cycle and frequency is selected so as to be appropriate for use with a digital compass of a smart phone, for example. This timing signal is passed to shift registers 206 and 208 that are used to generate magnetic signals having predetermined characteristics through the use of inductor 226. The magnetic field created by inductor 226 is comparable in strength to the Earth's magnetic field, which is on the order of 30 μT, and is, therefore, suitable to be received by the digital compass of a portable consumer device 940. As shown, circuit 200, through the shift registers, is configured to be responsive to the sequence of encoded bits representing the number “01001.”

In the embodiment of FIG. 2, a zero is encoded as a short pulse, and a one is encoded as a pulse that is twice as long. Through the use of capacitor 216 as a 0.1 capacitor a transmission rate of about 10 baud, or about 3 bits/s, was achieved. The transmission rate can be increased in other embodiments of the invention with different magnetic configurations and different encoding schemes.

As shown, the various components from the embodiment of circuit 200 include:
74HC/HCT597—8-bit shift register with input flip-flops
ICM 7555—General purpose timer
IN4001—Rectifier
IN4148—High speed diode
   One of skill in the art can readily find alternative components. Moreover, one of ordinary skill in the art understand that above discrete components can be integrated on a semiconductor wafer and made substantially smaller. A substantially smaller size provides further advantages for use in an authentication scheme. Also, other encoding and modulation schemes are known to those of skill in the art that provide further advantages as would be understood by one of ordinary skill in the art.

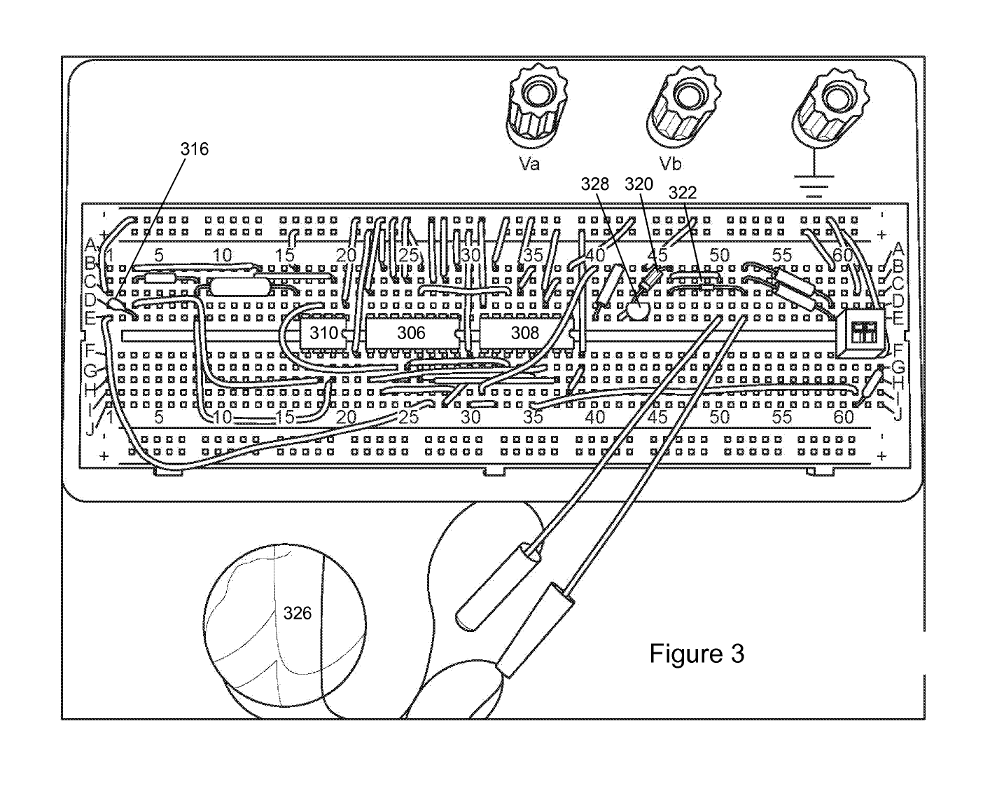

Shown in FIG. 3, is a breadboard implementation of the present invention that substantially uses commercially available off-the-shelf components. The correspondence between the components of FIGS. 2 and 3 is as follows:

| FIG. 2 Components by Reference | FIG. 3 Components by Reference |
|---|---|
| Number | Number |
| 206 | 306 |
| 208 | 308 |
| 210 | 310 |
| 216 | 316 |
| 220 | 320 |
| 222 | 322 |
| 226 | 326 |
| 228 | 328 |

One component that was not commercially available was inductor 326 of FIG. 3. For inductor 326, an inexpensive ferrite disk was used as a core for 300 turns of AWG 36 enameled copper wire that was rated for a maximum current of 36 mA.

The resulting inductor was estimated to generate a field of at least 10 μT at a distance of about 2 cm even when slightly off-center. Experiments confirmed that the estimate was correct. Also, experiments confirmed that a properly placed smart phone with a compass can get an appropriate reading of a transmitted signal.

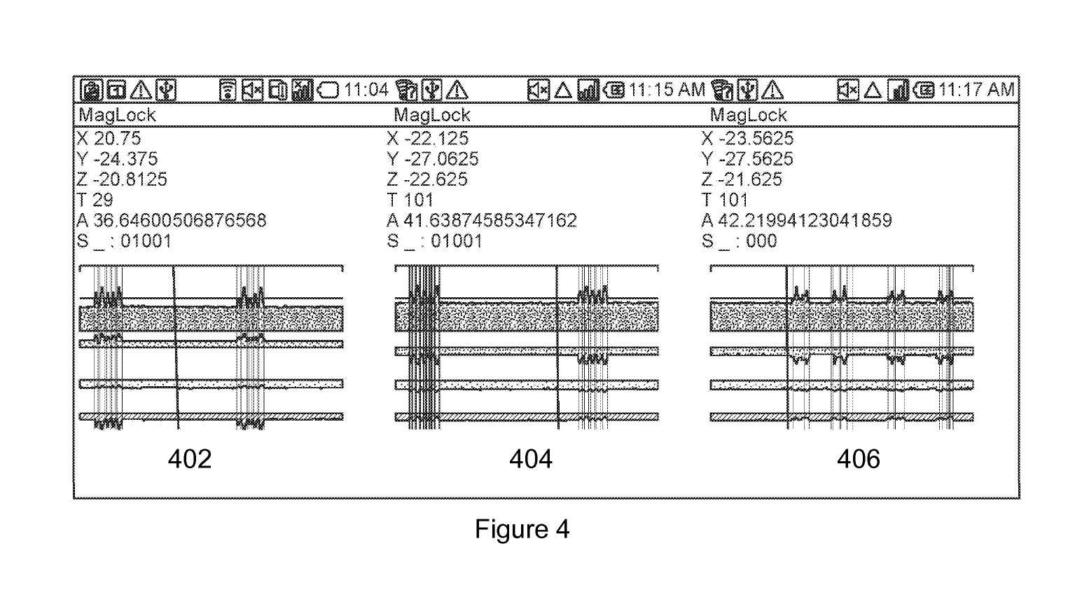

With an implementation of time-based encoding, a much more reliable scan was achieved by the smart phone. Shown in FIG. 4 are implementations of time-based encoding on different smart phones.

Shown in, plot 402 is the decoding of the bit string “01001” as achieved by a Google Nexus One smart phone. Shown in plot 404 is the decoding of the bit string “01001” as achieved by a decoded by a Motorola Droid smart phone. In this implementation a lower transmission rate is used (via a 0.47 uF capacitor) in order to match the lower sampling frequency offered by the phone's sensor (approximately 10 Hz versus 30 Hz on a Nexus One). Shown in plot 404 is the decoding of the bit string “01001” as achieved by a Droid smart phone. Experimentation demonstrated that higher transmission rates can introduce errors. Higher transmission rates should be considered in light of tolerable errors.

The present invention can be extended to transmitting more bits as well as using more sophisticated encoding schemes to achieve better utilization of the channel being used. In an alternative embodiment, commercially available Hall effect sensors rated to provide on the order of 1000 readings per second could be implemented. This offers 30 times higher bandwidth than what certain smart phone drivers are currently tuned to deliver.

In an embodiment, higher bandwidth is achieved by modifying software on the portable consumer device 940 of interest. Such a software update modifies its operation so as to be able to transmit between 100 and 300 bits per second, which is sufficient for authentication.

Static magnetic fields differ from electromagnetic (EM) waves in their sharp drop-off, proportional to the fourth power of the distance from the source. This is explained by the fact that amagnet is a dipole, and the resulting field connects the two poles, rather than radiate in space like an EM or sound wave.

A token according to an embodiment of the present invention emits EM waves by virtue of varying the magnetic field around an inductor. But these EM waves have a low frequency and their power, proportional to the frequency, is small.

While the drop in the strength of the magnetic field makes a magnetic token limited in terms of distance, it also makes the token less prone to snooping because an attacker would have to be nearby in order to detect and record a transmission.

Other embodiments of the present invention implement higher bit rates by making use of the three-dimensional aspects of a compass in order to transmit more data per unit time (or per unit current). Still another embodiment uses advanced encoding to transmit more data in a faster and more reliable way.

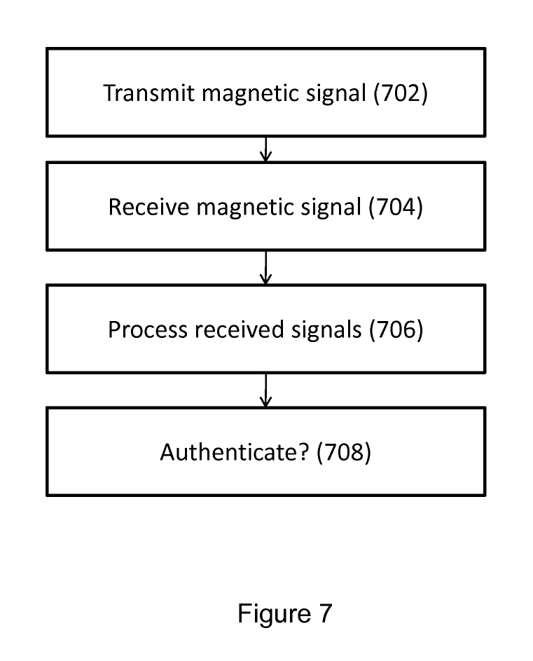

Shown in FIG. 7 is a method according to an embodiment of the invention for performing authentication tasks. As shown at step 702, a device transmits an encoded magnetic signal as described above. The magnetic signal is then received at step 704 by, for example, a compass within a personal communication device such as a smart phone. The received signals are for example the output of Hall-effect sensors that can be used in digital compasses. The received magnetic signals are then processed at step 706 to determine if they meet a predetermined criteria. In an embodiment, the predetermined criteria is that they must be a predetermined sequence. Other predetermined criteria may exist such as may be implemented through certain encryption schemes, including, for example, public/private key encryption. Other predetermined criteria is as explained in the present disclosure and as would be known to one of ordinary skill in the art. Where the predetermined criteria is met, authentication is performed at step 708.

In another embodiment of the invention, a microphone on a portable consumer device 940 is used for authentication. Due to its higher sampling frequency, the microphone offers higher communication bandwidth at lower power consumption compared to the digital compass.

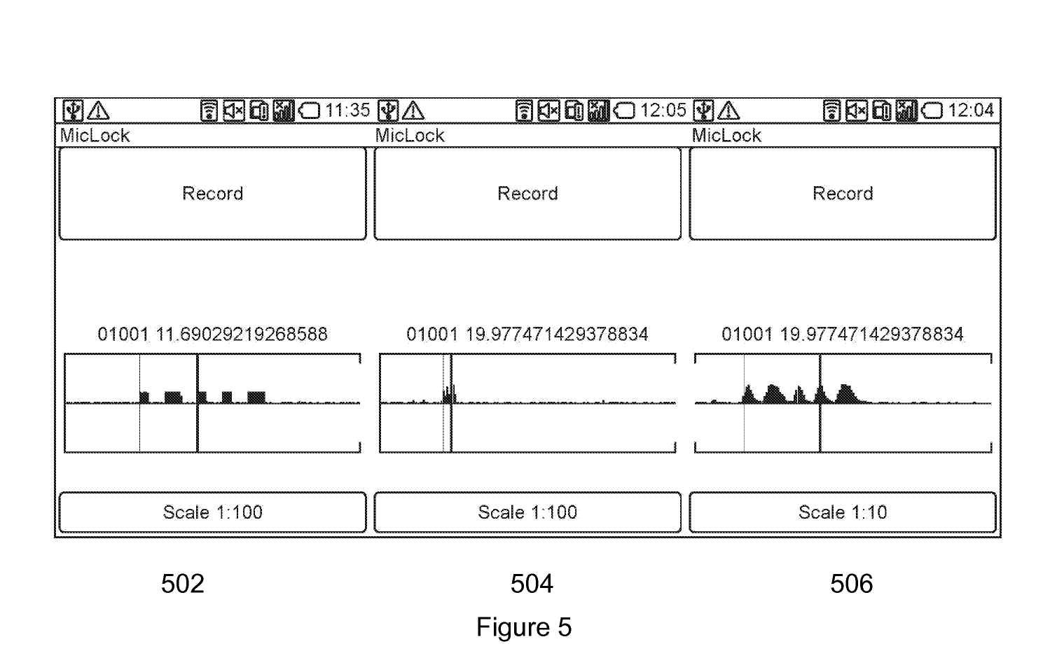

Shown in FIG. 5 are various configurations for transmitting a signal using a piezoelectric buzzer. In each condition, the carrier frequency is an audible signal at about 1200 Hz that implements amplitude-shift keying (ASK) as the modulation technique. On the receiver device (e.g., a smart phone), the carrier frequency is first isolated, then a decoding is performed that is similar to that used with the magnetic sensor. The signals shown in plots 502, 504, and 506 are after isolating the carrier frequency and performing some smoothing.

Shown in plot 502 is a representation for the bit string “01001” as decoded by a Nexus One phone. The bit string was transmitted over the course of 1 second, comprising about 10K samples. Shown in plot 504 is the bit string “01001” transmitted over 0.1 second, or 1K samples (using a 10 nF capacitor), as decoded by the Nexus One smart phone. Shown in plot 506 is a magnified view of the 0.1 second transmission where the zeros are shown to have shorter duration than the ones.

In other embodiments of the invention, transmission can implement modulation to achieve different bandwidth or transmission times as known to those of skill in the art. For example, telephone-based modulation techniques can be implemented.

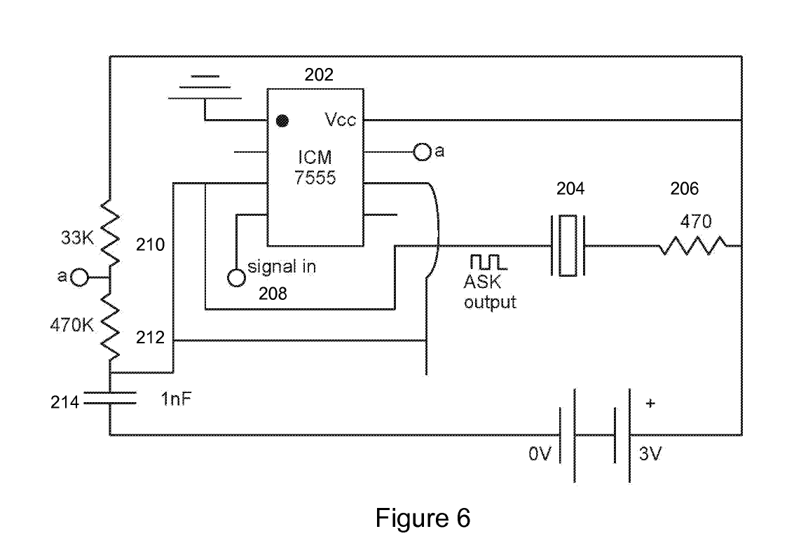

Shown in FIG. 6 is circuit 600 for microphone-based authentication according to the present invention. Among other things, circuit 600 includes a 7555 timer-based add-on circuit for ASK modulation over sound. Timer 202 is configured to operate at a specific frequency and duty cycle through the selection of resistors 210 and 212 and capacitor 214. Signal 208 is received from sequenced shift register output and modulated onto the output of timer 202. The output of timer 202 is a modulated signal that is connected to piezoelectric buzzer 204 as the current drawn is very low (thus a transistor is not needed in this version of the token). In an embodiment, the 1 nF capacitor 214 results in a carrier frequency of 1480 Hz.

By using a microphone as a receiver, this embodiment of the present invention achieved acceptable bandwidth. Importantly, very little power was required to generate sound waves using a piezoelectric buzzer.

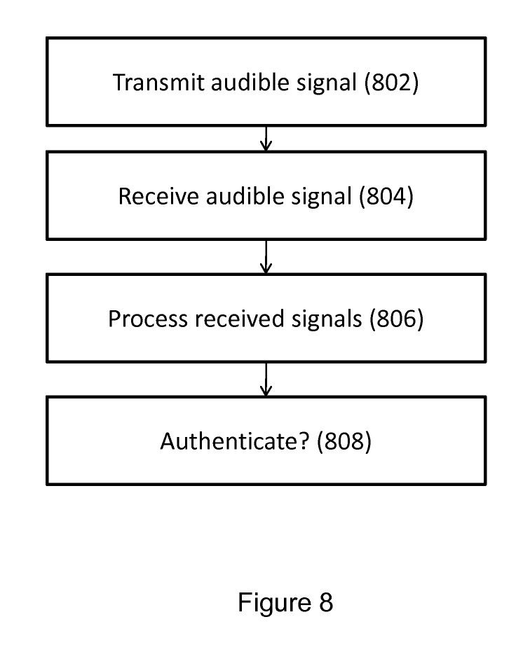

Shown in FIG. 8 is a method according to an embodiment of the invention for performing authentication tasks. As shown at step 802, a device transmits an encoded audible signal as described above. The audible signal is then received at step 804 by, for example, a microphone within a personal communication device such as a smart phone. The received signals are for example the output of a microphone that is used for spoken speech. The received audible signals are then processed at step 806 to determine if they meet a predetermined criteria. In an embodiment, the predetermined criteria is that they must be a predetermined sequence. Other predetermined criteria may exist such as may be implemented through certain encryption schemes, including, for example, public/private key encryption. Other predetermined criteria is as explained in the present disclosure and as would be known to one of ordinary skill in the art. Where the predetermined criteria is met, authentication is performed at step 808.

Table 3 summarizes the current drawn by the two embodiment described above (magnetic and sound). Also shown are estimates of how long the tokens can operate when powered by two different battery sources (a coin cell vs. camera battery) in two modes (continuous and on-demand). On-demand use assumes 20 authentications per day, taking up a total of 5 minutes of continuous transmission (a very conservative estimate). Shown in Table 3 is the current drawn by prototypes of the present invention and estimated time between battery replacement. Note that a battery's shelf life, typically about 10 years, will in some cases be shorter than the estimated time it takes a circuit to drain the battery.

TABLE 3

| | Current | | CR2450 (600 mAh) | | CR123A (1500 mAh) | |
|---|---|---|---|---|---|---|
| Device | Average | Peak | On-demand | Continuous | On-demand | Continuous |
| Magnetic | 6.91 mA | 16.00 mA | current too high | | >5 years | 210 h |
| Sound | 0.23 mA | 0.25 mA | >10 years | 2600 h | >10 years | 6500 h |

Table 4 compares the cost of materials for each of the embodiments described herein. Note that using sound instead of a magnetic field adds to the cost of the device but significantly increases the available bandwidth and lowers the current drawn by the circuit. But also note that that the cost of the circuit boards, wiring, batteries, and assembly is not included.

TABLE 4

| | Cost (USD) | | |
|---|---|---|---|
| Type | Unit | Magkey | Mickey |
| Timer IC | $0.20 | $0.20 | $0.40 |
| Shift Register IC | $0.25 | $0.50 | $0.50 |
| Transistor | $0.15 | $0.15 | |
| Diode | $0.01 | $0.02 | |
| Capacitor | $0.05 | $0.05 | $0.10 |
| Resistor | $0.01 | $0.05 | $0.08 |
| Inductor (Coil) | $0.10 | $0.10 | |
| Piezo Buzzer | $0.20 | | $0.20 |
| Total | | $1.07 | $1.28 |

Variations and improvements to the embodiments disclosed in the present invention would be readily known to those of skill in the art. For example, those of skill in the art are aware of various encoding and modulation schemes that would be appropriate for use with the present invention. Those of skill in the art would also understand that bandwidth can be increased by modifying the receiver to offer a higher sampling rate. This may be particularly applicable to digital compass implementations.

Moreover, those of skill in the art understand that smart phone microphones can be tuned or upgraded to receive ultrasound (and sample at an accordingly higher rate), which opens up the opportunity to transmit data over ultrasound. As a beneficial side effect, using ultrasound makes a transmission inaudible, and thus less obnoxious.

One of skill in the art would also understand that the present invention may include protection against replay attacks. With active authentication tokens, for example, this problem can be addressed. Challenge-based and single-packet protocols in this context are desirable extensions of the present invention

The present invention as implemented on a portable consumer device 940 such as a smart phone can be adapted to alternative transmission mechanisms including:
Using a mechanical “clicker” as the sound generator. Instead of an active circuit generating sound signals, a user can use a device which generates a specific sound pattern when clicked mechanically (similar to some children's toys, for example).
Using a mechanical system of magnets that generates a predetermined pattern in time and space. This is similar to an embodiment of the present invention that implements a user-powered mechanical token.
Using a key which is run across the surface of the smart phone to create a mechanical vibration. This embodiment may be implemented using a human-powered transmission that can be “read” via the device's accelerometer. Such a key is usable in conventional settings, by embedding an accelerometer in a door—the advantage over traditional keys is that such a lock will be highly tamper-resistant.

The present invention implements inexpensive hardware authentication tokens and methods for using them that are suitable for use with smart phones, as well as laptop and desktop computers and other security infrastructure including conventional doorways. The tokens of the present invention can be presently built in volume for about $1.00 each, and, under normal use, can last for years when powered by a coin-type 3V battery.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the read/write while maintaining substantially the same functionality without departing from the scope and spirit of the present invention. For example, the read sensor may be of a type that has current flowing through it in a direction that is transverse to the bottom and shared shields, with the bottom and shared shields serving as current carrying conductors for the magnetoresistor current. In addition, although the preferred embodiment described herein is directed to a thin film head for a hard disc drive system, it will be appreciated by those skilled in the art that the teachings of the present invention can be applied to other magnetic systems, like tape drives, without departing from the scope and spirit of the present invention.

What is claimed is:

1. A method for performing token-based authentication comprising:
receiving a transmitted magnetic signal using a compass;
generating a first set of signals responsive to the received magnetic signal;
comparing the first set of signals to a reference;
generating an authentication signal responsive to the comparison of the first set of signals to the reference.

2. The method of claim 1, wherein receiving the transmitted magnetic signal includes placing the compass in close proximity to a transmitting device that generates the transmitted magnetic signal.

3. The method of claim 1, wherein the reference is a predetermined sequence.

4. The method of claim 1, further comprising filtering the received magnetic signal.

5. The method of claim 1, wherein the compass is a Hall-effect sensor.

6. The method of claim 1, wherein the transmitted magnetic signal has a value of approximately 30 μT.

7. A computer-readable medium including instructions that, when executed by a processing unit, cause the processing unit to performing token-based authentication, by performing the steps of:
receiving a transmitted magnetic signal using a compass;
generating a first set of signals responsive to the received magnetic signal;
comparing the first set of signals to a reference;
generating an authentication signal responsive to the comparison of the first set of signals to the reference.

8. The computer-readable medium of claim 7, wherein receiving the transmitted magnetic signal includes placing the compass in close proximity to a transmitting device that generates the transmitted magnetic signal.

9. The computer-readable medium of claim 7, wherein the reference is a predetermined sequence.

10. The computer-readable medium of claim 7, further comprising filtering the received magnetic signal.

11. The computer-readable medium of claim 7, wherein the compass is a Hall-effect sensor.

12. The computer-readable medium of claim 7, wherein the transmitted magnetic signal has a value of approximately 30 μT.

13. A computing device comprising:
a data bus;
a memory unit coupled to the data bus;
a processing unit coupled to the data bus and configured to
receive a transmitted magnetic signal using a compass;
generate a first set of signals responsive to the received magnetic signal;
compare the first set of signals to a reference;
generate an authentication signal responsive to the comparison of the first set of signals to the reference.

14. The computing device of claim 13, wherein the reference is a predetermined sequence.

15. The computing device of claim 13, wherein the processing unit is further configured to filter the received magnetic signal.

16. The computing device of claim 13, wherein the compass is a Hall-effect sensor.

17. The computing device of claim 13, wherein the transmitted magnetic signal has a value of approximately 30 μT.

18. An apparatus for use in token-based authentication, comprising:
a sensor configured to generate signals;
a processor configured to receive the signals, wherein the processor is configured to
compare the signals to a pattern of signals, and
authenticate the signals in response to the comparison, and generate a signal responsive to the authentication.

19. The apparatus of claim 18, wherein the signals are magnetic signals.

20. The apparatus of claim 18, wherein the signals are audible signals.

21. The apparatus of claim 18, wherein the signals are ultrasonic signals.

22. The apparatus of claim 18, wherein the sensor is a digital compass.

23. The apparatus of claim 18, wherein the sensor is a microphone.

24. An apparatus for use in token-based authentication, comprising:
a timing device configured to generate a periodic signal;
at least one register for storing a reference sequence, wherein the at least one register is coupled to the timing device;
a magnetic transmitter coupled to the timing device and the at least one register, wherein the magnetic transmitter is configured to generate a magnetic signal responsive to the reference sequence.

25. The apparatus of claim 24, wherein the magnetic transmitter includes an inductor.

26. The apparatus of claim 24, wherein the magnetic transmitter is configured to transmit a magnetic signal of approximately 30 μT.

27. The apparatus of claim 24, wherein the timing device generates a square wave of approximately 50% duty cycle.

28. The apparatus of claim 24, wherein the magnetic transmitter includes at least one magnet.
